(19) United States
(12) Patent Application Publication
(10) Pub. No.: US 2011/0074358 A1
(43) Pub. Date: Mar. 31, 2011

(54) Battery Protection Device which Utilizes Light Current to Control Heavy Current

(76) Inventor: Chung-Ho LO, Taipei City (TW)

(21) Appl. No.: 12/261,222

(22) Filed: Oct. 30, 2008

(30) Foreign Application Priority Data
Dec. 26, 2007 (TW) 096150272

(51) Int. Cl. H02J 7/00

(52) U.S. Cl. 320/136

(57) ABSTRACT

A battery protection device which utilizes light current to control heavy current primarily uses an electronic control circuit of light current in combination with a large current control element, such as a relay, to protect large current recharging and discharging of a battery. The light current electronic control circuit includes three main circuits: a main control (micro control unit) circuit, a sampling circuit and a relay control circuit. The relay is primarily a latching relay, allowing the relay to have a self-locking function after operation, without continually supplying electricity to a solenoid.

### BACKGROUND OF THE INVENTION

a) Field of the Invention

The present invention relates to a technology by which recharging and discharging of large current can be controlled with a battery protection board.

b) Description of the Prior Art

It is known that a battery is an important energy tool. In order to develop new energy, more and more kinds of batteries arise and their application is getting broader and broader. In terms of the recharging and discharging characteristics as well as operation properties, the batteries can be generally divided into a primary cell and a secondary cell, wherein the secondary cell refers to the battery that can be reused. Hence, the secondary cell is more economical in cost and is therefore widely appreciated by general public, which is also the subject of the present invention.

When a battery is recharging or discharging, in order to apply the battery more safely and to prolong a lifetime of usage of the battery, some higher end battery will be installed with a protection circuit board to measure an application status of the battery and to detect variations of voltage and temperature during recharging or discharging, such that if an abrupt short-circuit occurs, the recharging or discharging of the battery can be turned off immediately, thereby achieving an object of protecting the battery and the circuit, and preventing from an ordeal by innocence. The aforementioned protection circuit device is widely available in an ordinary circuit design, such as a control and protection device for recharging and discharging a power generator, a Lithium-ion battery recharging and discharging circuit structure, and a battery recharging and discharging control circuit. Although these devices have different structures and features, they are all constituted by electronic elements, such as capacitors, resistors, diodes and triodes, which can only sustain with light current. Therefore, under a limitation of using the light current, it will spend a very long time to recharge or discharge the battery. Accordingly, in this busy industrial society, demands cannot be satisfied at all. On the other hand, if large current is introduced by taking a risk, then the electronic elements can be burned down easily. Hence, this issue has been always a bottleneck in the industry and could not be broken through.

To recharge the battery into which large current should be introduced, there is only one protection device design called MOS (Metal-Oxide Semiconductor) to control an on or off of current. However, as MOS should be kept at an energized state to achieve a control effect, there are two shortcomings. The first shortcoming is that MOS consumes more electricity. The second one is that when large current passes through MOS, high heat will occur. To solve an issue of heat dissipation derived from the high heat, an electric fan is usually installed on MOS for cooling. Thus, size and weight of the device will be increased correspondingly; in a mean time, more energy will be consumed. On the other hand, if the electric fan is damaged and is not replaced in time that the high heat cannot be expelled in time, then related electronic equipment will be burned down easily, or surrounding objects can be even affected to start a fire, which is a shortcoming of MOS and is also an issue that is eager to be solved by the related industry.

The aforementioned problems can be solved by a better circuit structure design. Therefore, a brand new battery protection device is specifically designed, such that the battery can be applied safer and can save energy.

### SUMMARY OF THE INVENTION

The primary object of the present invention is to provide a battery protection device which utilizes light current to control heavy current, wherein a conventional micro control unit (MCU) employs a light current system to carry out certain detection and determination, and then to transmit an “off” or “on” instruction to a relay control circuit, corresponding to a status of determination according to required conditions that are pre-configured. Next, the relay control circuit will send the “off” or “on” instruction to a latching relay, so as to control whether battery current can be recharged (discharged). Furthermore, since current and voltage of a coil of the latching relay for controlling close-circuit or open-circuit are very low, whereas current that can flow through a contact can be very large, an effect that small current (light current) controls large current (heavy current) can be achieved, thereby protecting the safety of and prolonging the lifetime of usage of the battery.

Accordingly, the present invention includes a circuit board on which is serially connected with at least two batteries to assemble into a battery supply unit. The battery supply unit is connected with an MCU through a sampling circuit, and transmits this message to the MCU as a reference of determination for controlling other units according to data configured by a program. The MCU can be connected respectively with a power supply loop and a base voltage loop of a voltage regulation system, and then forms a complete loop with the battery supply unit. That loop is further serially connected with a latching relay and a relay control circuit; whereas, a jaw and a contact of the latching relay are kept at a normally connected state magnetically, and the relay control circuit performs an on or off function to the relay depending upon determination of the MCU on voltage data of each electrode.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a basic structure of the present invention.

FIG. 2 shows a flow diagram of an operation of the present invention.

FIG. 3 shows a schematic view of an action of the present invention.

### DETAILED DESCRIPTION OF THE PREFERRED EMBODIMENTS

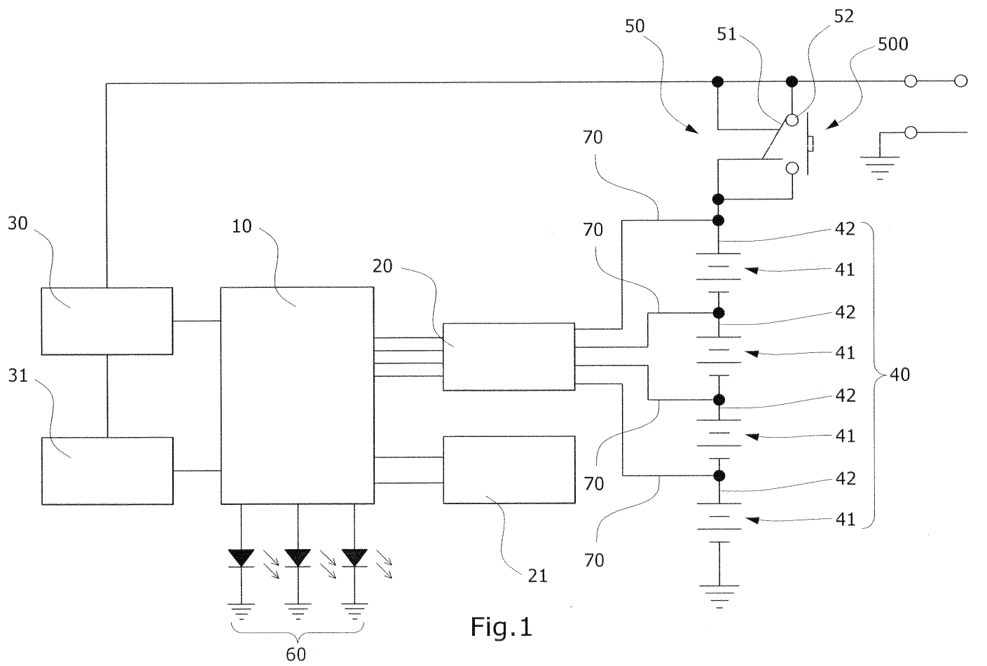

Referring to FIG. 1, the present invention comprises primarily a circuit board, on which is serially connected with at least two batteries 41 to assemble into a battery supply unit 40 (in this drawing, four batteries are used as an example of implementation). The battery supply unit 40 is connected with an MCU 10 through a sampling circuit 20, with a lead wire 70 being connected at an electrode 42 between every two batteries 41 to the sampling circuit 20. The sampling circuit 20 accesses voltage of each electrode 42 and then transmits this message to the MCU 10 which uses data pre-configured by a program to serve as a reference of determination for controlling other units.

The MCU 10 can be connected respectively with a power supply loop 30 and a base voltage loop 31 of a voltage regulation system, and then forms a loop with the battery supply unit 40. The loop is a kind of electronic control circuit which can apply light current.

The loop is further serially connected with a latching relay 50 and a relay control circuit 21. A jaw 51 and a contact 52 of the latching relay 50 are kept at a normally connected state magnetically, and the relay control circuit 21 performs an on or off control function to the latching relay 50 depending upon determination of the MCU 10 on the voltage data of each electrode 42.

The MCU 10 can be also connected with a signal indication light 60 which illuminates different colors when various conditions appear, such that messages for recharging or discharging can be differentiated and provided to facilitate determining an existing action status of the protection board.

The sampling circuit 20 can have a different design according to a number of batteries 41 that are serially connected, acquiring a proper voltage value at the proper electrode 42 to provide the MCU 10 for determination.

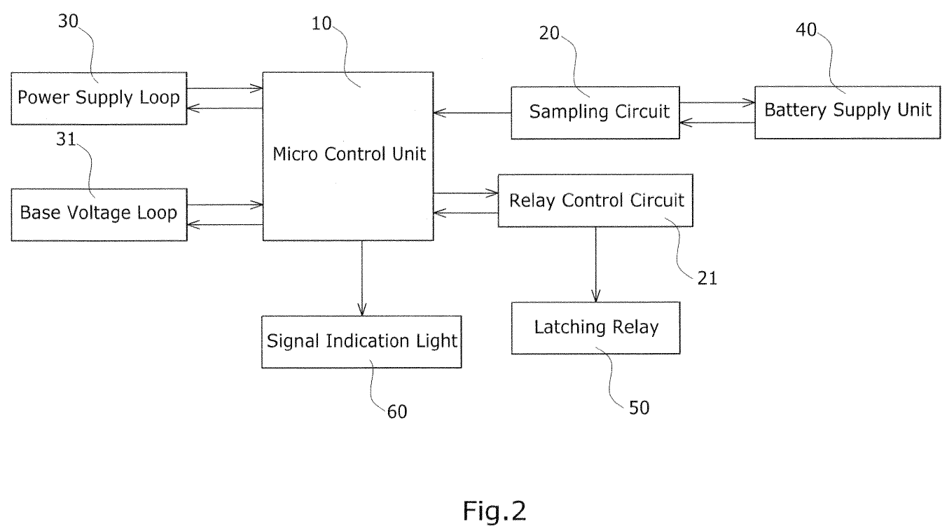

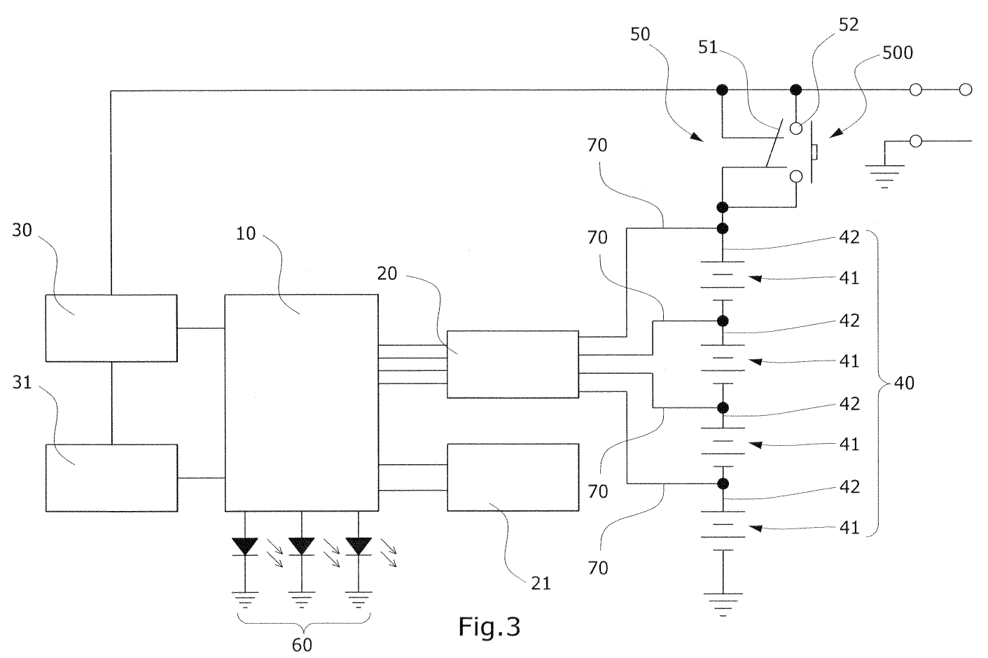

Referring to FIG. 1 and FIG. 2, the jaw 51 and contact 52 on the latching relay 50 are kept at the normally connected state magnetically. If the voltage of each electrode 42 in the battery supply unit 10 is within a normal range, then the MCU 10 will not issue any instruction to the relay control circuit 21. On the other hand, if the voltage of each electrode 42 in the battery supply unit 40 is determined to be abnormal, then, as shown in FIG. 3, an instruction will be issued to the relay control circuit 21 which will send out control current to break off the jaw 51 and contact 52 of the latching relay 50. At this time, as the power supply unit 40 cannot supply electricity to all external elements, all recharging circuits cannot recharge the power supply unit 40 either. Therefore, the battery protection effect has been achieved.

At this time, if re-energizing is to be performed, then a Reset button 500 should be pressed first (as this is an ordinary electronic and circuit technology, no further description is included in the drawings), and electricity will be supplied to the entire control loop momentarily. Then, a normal condition is restored again, until that the MCU 10 detects the abnormality once more to proceed another cycle.

In the present invention, the conventional MCU circuit utilizes the light current system to perform certain detection and determination operations, and then transmits the “off” or “on” instruction to the relay control circuit corresponding to the condition of determination according to the pre-configured required conditions. Next, the relay control circuit will send the “off” or “on” instruction to the latching relay to control whether the battery current can be recharged or discharged. As the current and voltage of the coil of the latching relay for controlling the close-circuit or open-circuit are very low, whereas the current that can flow through the contact can be very large, the object of using the small current (light current) to control the large current (heavy current) can be achieved, thereby protecting the safety of and prolonging the lifetime of usage of the battery.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A battery protection device which utilizes light current to control heavy current, comprising a circuit board on which is serially connected with at least two batteries to assemble into a battery supply unit, with the battery supply unit being connected with a micro control unit (MCU) through a sampling circuit and transmitting this message to the MCU to serve as a reference of determination for controlling other units, depending upon data configured by a program; the MCU being connected respectively with a power supply loop and a base voltage loop of a voltage regulation system, and then forming a complete loop with the battery supply unit; the loop being further serially connected with a latching relay and a relay control circuit, with a jaw and a contact of the latching relay being kept at a normally connected state magnetically, and the relay control circuit performing an on or off function to the relay according to determination of the MCU on a voltage data of each electrode.

2. The battery protection device which utilizes light current to control heavy current, according to claim 1, wherein the loop of MCU is further provided with a signal indication light.

3. The battery protection device which utilizes light current to control heavy current, according to claim 1, wherein the loop of MCU is further provided with a Reset button.

4. The battery protection device which utilizes light current to control heavy current, according to claim 1, wherein a lead wire is connected at an electrodes between each two batteries (i.e., cells) of the battery supply unit to the sampling circuit which accesses a voltage message of each electrode and transmits to the MCU.

5. The battery protection device which utilizes light current to control heavy current, according to claim 1, wherein the program in the MCU is provided with a different design according to a number of batteries that are serially connected.
